(19) United States
(12) Patent Application Publication
(10) Pub. No.: US 2017/0043213 A1
(43) Pub. Date: Feb. 16, 2017

(54) Method and System for Determining the Quality of Running

(71) Applicant: Martin DAUMER, Munich (DE)

(72) Inventor: Martin DAUMER, Munich (DE)

(21) Appl. No.: 14/826,959

(22) Filed: Aug. 14, 2015

(51) Int. Cl. A63B 24/00; G09B 19/00; H04W 4/00; H04B 1/3827; H04W 4/02

(52) U.S. Cl. CPC A63B 24/0062; H04B 1/385; H04W 4/027; H04W 4/008; A63B 24/0006; G09B 19/0038; H04B 2001/3855

(57) ABSTRACT

A method for determining the quality of running of a test subject includes: measuring at least two orthogonal acceleration values a_{c} and a_{c′} of the test subject each at a plurality of times tᵢ, wherein a_{c} and a_{c′} are each one differently selected from the group of: acceleration a_{z} of the test subject in the down-up direction, acceleration a_{y} of the test subject in the right-left direction, and the acceleration aₓ of the test subject in the backward-forward direction; wherein the down-up direction, the left-right direction and the backward-forward direction form a Cartesian coordinate system for the test subject; determining the area Aᵢ defined by the origin (0,0) and the points (a_{c}(tᵢ),a_{c′}(tᵢ)) and (a_{c}(tᵢ₋₁), a_{c′}(tᵢ₋₁)); and calculating the accumulated area A (t_{N})=Σᵢ₌₁^{N} Aᵢ by adding the areas Aᵢ until a point in time t_{N}.

### FIELD OF THE INVENTION

The present invention relates to the field of determining the quality of a running style. More generally, the present invention relates to determining the quality of running inasmuch as this quality is not only dependent on the running style of an individual but also on other factors such as footgear that is worn during running Further, the present invention most generally relates to determining the quality of locomotion of a test subject as such, e.g. walking, particularly of types of locomotion which show a certain periodicity.

### BACKGROUND

The present invention uses acceleration data from an activity measuring device such as is described in U.S. Pat. No. 7,640,804 which is co-invented by the present inventor. Such an activity measuring device is commercially available under the tradename acitbelt™ (cp. also http://www.actibelt.com/). Essentially, The actibelt™ is a three-dimensional acceleration measuring device which measures the acceleration of the body during walking or running in three spatial axes aₓ, i.e. the acceleration in the backward-forward direction, a_{y}, i.e. the acceleration in the right left direction and a_{z} the acceleration in the down-up direction. Due to its small size and its low weight the sensor can be mounted behind the buckle of a belt. Thus, the acceleration data are measured close to the center of mass of the body which in turn lies close to the hight of the navel. The acceleration data measured in this manner are transmitted via Bluetooth™ in real time to a Smartphone. The actibelt™ measures accelerations with a frequency of 100 times per second. The actibelt™ has been developed for long term monitoring of patients in order to evaluate the success of a therapy and to individually design future therapies.

Conventional approaches for measuring the quality of running use force plates and video analysis which are only adapted for artificial environments and do only allow for little interpretation as specially under real running conditions.

In this regard attention is drawn to the article “Foot strike patterns and collision forces in habitually barefoot versus shod runners” by Daniel E. Lieberman, Madhusudhan Venkadesan, William A. Werbel, Adam I. Daoud, Susan D'Andrea, Irene S. Davis, Robert Ojiambo Mang'Eni and Yannis Pitsiladis published in NATURE |Vol 463| 28 Jan. 2010, pages 531 to 536.

The present inventor has carried out considerable research in the field of the present invention. In the following several related papers are cited together with their abstracts; the disclosures of all these papers are incorporated herein by reference in their entireties: Daumer M, Schneider A N, Mrowca D, Ding R, Gao H, Christian L. (2014) Meta Products towards a “gait/running style app”. PeerJ PrePrints 2:e370v1 https://dx.doi.org/10.7287/peerj.preprints.370v1 Abstract: Background: The individual running style has an impact on the running performance as well as the running injury risk. In order to increase the performance and lower the injury risk, runners should be educated towards a healthy running style. But before advices can be made it is crucial to distinguish running styles from each other. Aim: The stretch goal is to build a running style app, which is able to track and display the user's current running style by using accelerometry data, based on which advice can be given for a healthy and efficient running style with the help of gaming tools. To validate the approach, a gold standard with outdoor running acceleration data has to be created. Methods: The accelerometry data used by the smartphone app is gathered from the “actibelt™”, an accelerometer included in a belt buckle. This sensor collects data close to the body COM in all three dimensions which is transferred to a smartphone via Bluetooth in real-time. The focus of this work is the validation of an acceleration based detection of different running styles, namely heel strikes, midfoot strikes and forefoot strikes. Features, which are able to clearly distinguish different running styles, have to be extracted out of the accelerometry data with machine learning techniques (SVM). Laboratory experiments have been conducted to analyze the actibelt™ data of three test persons performing heel, midfoot and forefoot strikes on a pressure sensitive treadmill with video control. As running apps are mainly used outdoors, the results had to be reproduced with outdoor running data. In an extreme ends approach four test persons with different running experience ranging from professional to occasional runners were asked to successively run on their heels, midfoot and forefoot, while accelerometry data was recorded and synchronized with mobile high speed video. The different running styles were performed on different substrates, with different shoes and speeds. Discussion/Conclusion: While significant differences in the accelerometry data of the running styles have been observed in the laboratory, those differences couldn't be reproduced in outdoor environments. Characteristic peak patterns (Lieberman, nature 463, 531-535) could be reproduced in the laboratory but disappeared in outdoor running The most distorting aspects are the harder and less comfortable surface and an irregular speed compared to treadmill running Hence, for a reliable detection of the running style, the actibelt™ data may be complemented by further sensors, e.g. placed in the socks. A promising idea is to influence the stride frequency of runners at given speeds to improve the individual running style.

Daumer M, Trost M, Subkowski P, Schneider A, Mrowca D, Ding R, Gao H, Walther M, Lederer C. (2014) On the measurement of running style. PeerJ PrePrints 2:e496v1 https://dx.doi.org/10.7287/peerj.preprints.496v1 Abstract: The measurement of running style must be ecologically valid. The individual running style has an impact on the running performance as well as the running injury risk. In order to increase the performance and lower the injury risk, runners should be educated towards a healthy running style. But before advice can be made it is crucial to distinguish running styles from each other. Thus, it is interesting to detect and optimize the running style of individuals. The goal is to evaluate the possibility for a running style app using accelerometry data, which is able to track and display the user's current running style by using accelerometry data, based on which advice can be given for a healthy and efficient running style with the help of gaming tools (meta product). To validate the approach, a gold standard with outdoor running acceleration data has to be created.

Daumer M, Fumbarev J, Ellenrieder N, Schaermann A, Subkowski P, Lederer C. (2015) “Kleist”: Ideas for new parameter to measure running style. PeerJ PrePrints 3:e1202 https://dx.doi.org/10.7287/peerj.preprints.976v1 Abstract: Many people prefer running to keep in shape. In recent years many self-tracking and self-optimization gadgets has become popular especially for running. We are interested in the quality of running because individual running style has an impact on the running performance as well as on the running injury risk. Hence, in order to increase the performance and lower the injury risk, runners should be educated towards a healthy running technique. Before making an advice, it is crucial to distinguish between different running styles.

Daumer M. On The Measurement of Running Style 1: Risks and Benefits in Transitioning To Barefoot/Minimal Footwear Running J J Sport Med. 2015, 2(3): 014. Abstract: Background: The individual running style has an impact both on running performance and on running injury risk. The runner aiming to improve his running style finds himself confronted with contradicting recommendations from the literature [1-8] and there exist even smartphone apps, social platforms, video tools etc. claiming to coach the runner towards a healthier running style. The goal of this paper is to present quantitative estimates for the risks and benefits in transitioning to barefoot/minimal footwear running from our recent cross-sectional on-line study. Methods: We designed and performed an on-line survey using in a community of minimal footwear/barefoot (mf/b) runners. The sample consisted of runners who successfully switched to mf/b running, without a formal distinction between professionals and amateurs. The on-line survey was performed using Google forms; the raw data are publicly available under https://docs.google.com/spreadsheets/d/19urx4eMt9CgJEXQUOtHbax_fngP_5DBz5EZHzFSN Ak/edit?pli=1#gid=0. All statistical analyses were performed in R 3.1.2. [9]. Results: In total 226 runners filled out the questionnaire, 15 subjects were excluded from the analysis due to invalid data. From this data set, only those subjects were included in the analysis who reported at least 50 km in each running phase (shod, transition, mf/b) (173 (82%) subjects, 137 male, 15-71 years of age [mean=40, sd=9.8]). The mean numbers of injuries per 10.000 km in three phases where 8.0 [sd=16.2], 23.4 [sd=48.8], and 3.5 [sd=15.7] respectively. The variance of running related injuries was significantly increased during the transition period from shod running to mf/b and the detailed analysis (different trends for mean and median) suggests that there is a subgroup of runners with highly increased risk of injury during this phase. The injury rate per km was markedly lower—about 50%—in mf/b than in shod running; this reduction of injuries however should be considered with care due to possible selection bias.

### SUMMARY

Therefore, in light of the above, and for other reasons that become apparent when the invention is fully described, an object of the present invention is to provide an automatically determinable measure of the quality of running (style).

A further object of the present invention is to provide a measure of the quality of locomotion, particularly of running, which is both meaningful and reproducible.

Yet a further object of the present invention is to provide a measure of the quality of running which is adapted for different running environments, that is to say, which cannot only be used for runners in a “safe” environment such as a treadmill but can also be used outdoors when running on different (irregular) terrains.

A still further object of the present invention is that the quality of running can be determined for a single individual under different condition such as the individual wearing various foot gear, for instance, jogging shoes. As a result the quality of the conditions, e.g. the foot gear, can be measured insofar as their negative or positive effects on the running style of the individual can be determined.

Another object of the present invention is to provide support to an individual that is seeking to improve his or her running style/technique. Both good and bad quality running can be detected and serves as feedback to the individual. This can be in real-time, for instance, during a running race such as a marathon or as a post-analysis, for instance, during training. The detection of a bad running style may also serve to prevent injuries of the individual. Particularly, different running styles such as heel strikes, forefoot strikes and mid-foot strikes can be detected and distinguished.

Yet another object of the present invention is to provide a means to scout running talents or to select runners for a sport competition out of a team other than assessing their achievements in running competitions or relying on a subjective opinion about their performance or running styles.

Still another object of the present invention is to provide a quantitative measure of the success of rehabilitation of an individual after an accident such as a fall or the developments of a patient under a therapy by analyzing the progress in regaining mobility.

The aforesaid objects are achieved individually and in combination, and it is not intended that the present invention be construed as requiring two or more of the objects to be combined unless expressly required by the claims attached hereto.

According to a first aspect the present invention relates to a method for determining the quality of running of a test subject comprising the following steps: measuring at least two orthogonal acceleration values a_{c} and a_{c} of the test subject each at a plurality of times tᵢ, wherein a_{c} and a_{c}, are each one differently selected of the group of: acceleration a_{z} of the test subject in the down-up direction, acceleration a_{y} of the test subject in the right-left direction, and the acceleration aₓ of the test subject in the backward-forward direction; wherein the down-up direction, the left-right direction and the backward-forward direction form a Cartesian coordinate system for the test subject; determining the area Aᵢ defined by the origin (0,0) and the points (a_{c}(tᵢ),a_{c′}(tᵢ)) and (a_{c}(tᵢ₋₁), a_{c′}(tᵢ₋₁)); and calculating the accumulated area A(t_{N})=Σᵢ₋₁^{N}Aᵢ by adding the areas Aᵢ until a point in time t_{N}.

The present invention is preferably computer-implemented so the measurement of acceleration values is initiated by a processor using a program stored in the memory of a computer, wherein the same or a different processor using the same or a different program stored in the same or a different memory of the same or of a different computer determines, in particular, calculates the partial areas Aᵢ as well as the accumulated areas A(t_{N}) serving as a quality measure of the locomotion.

Preferably, the method further comprises a step of evaluating A(t_{N}) for obtaining the quality of running of the test subject, wherein the step of evaluating A(t_{N}) further comprises: obtaining a sliding mean value for A(t_{N}) for a time interval t_{N}-Δt_{N} to t_{N}; and
comparing A for different times t_{N} and t_{N′}, wherein a lower value of A indicates a better quality of running, wherein equal values of A indicate the same quality of running, wherein a higher value of A indicates a worse quality of running, and wherein the different times t_{N} and t_{N′} form part of the same measurement series or of different measurement series, and/or
comparing A with a predetermined threshold value, wherein a value of A lower than or equal to the predetermined threshold value indicates a good quality of running, and wherein value of A higher than the predetermined threshold value indicates a bad quality of running. Generally, the lower A is the better can be considered the quality. This is based on the inventor's recognition that accelerations in general have to be considered bad during the process of locomotion. They naturally cannot be avoided but their minimum is generally desired. However, it should be noted that in some rare applications a generally less good quality could be considered as actually being better, for instance, when a runner seeks to improve his running style on a special terrain which would make for instance hard push-offs (and therefore, associated high acceleration values of a_{z}) of the feet during running desirable.

In a preferred embodiment, the sliding mean value for A(t_{N}) is a weighted sliding mean value. For instance, the weighting can be made for taking into account that different phases of the locomotive cycle have more or less importance.

Generally, the sliding mean value for A(t_{N}) is determined or calculated per time unit, and wherein Δt_{N} is a constant time interval Δt equal to the time unit. Alternatively or in addition thereto, the sliding mean value for Δ(t_{N}) is determined per n steps, wherein n is a positive integer. To this end, also the steps of the test subject have to be detected so that Δt_{N} is a time interval corresponding to n steps of the test subject. In another variant of the present invention, the speed of the test subject can be determined and the sliding mean value for A(t_{N}) is then determined per distance unit, and wherein Δt_{N} is a time interval corresponding to the distance unit passed by the test subject. Of course, when the speed is known time can easily be converted into distance.

Preferably, A(t_{N}) is calculated by the following formula:

$$A ( {t}_{N} ) = {\sum }_{i = 1}^{N} {A}_{i} = \frac{1}{2} {\sum }_{i = 1}^{N} \vert ( \begin{matrix}{a}_{c} ( {t}_{i - 1} ) \\ {a}_{c ′} ( {t}_{i - 1} )\end{matrix} ) \vert \cdot \vert ( \begin{matrix}{a}_{c} ( {t}_{i} ) \\ {a}_{{c}^{′}} ( {t}_{i} )\end{matrix} ) \vert \cdot sin α ( {t}_{i} )$$

wherein α(tᵢ) is the angle between the vectors (a_{c}(tᵢ₋₁),a_{c′}(tᵢ₋₁)) and (a_{c}(tᵢ),a_{c′}(tᵢ). This formula can easily be obtained by trigonometry as will be explained further below.

It is generally preferred to measure the acceleration values a, and a_{c′} of the test subject each with a frequency of 100 Hz. This frequency allows for the inventive method to have enough resolution of the locomotion so that meaningful results can be obtained.

Preferably, the selected orthogonal acceleration values a_{c} and a_{c′} are aₓ and a_{z}. By selecting or measuring the acceleration aₓ of the test subject in the backward-forward direction and the acceleration a_{z} of the test subject in the down-up direction an important quality measure of the locomotion is obtained. Both most important aspects of locomotion, i.e. gravity and the thrust in the direction of locomotion are then considered. Alternatively, other two acceleration parameters such as aₓ and a_{y} could be used for the present invention, i.e. the acceleration aₓ of the test subject in the backward-forward direction and acceleration a_{y} of the test subject in the right-left direction. In the latter case, a particular quality measure is obtained indicating a jerky locomotion style as far as particularly left-right movements during the locomotion are concerned.

A preferred way of interpreting the results obtained by the inventive method can be realized by displaying the measured acceleration values a_{c}(tᵢ) and a_{c′}(tᵢ) for subsequent times tᵢ in a two-dimensional Cartesian coordinate system with the abscissa being the a_{c} axis and the ordinate being the a_{c′} axis. In the case of running, the resultant curve for aₓ and a_{z} is a ballon-shaped curve that is passed through during each running cycle. For instance, by simply observing in this diagram the different shapes of the curves in various running cycles qualitative observations can readily be made.

According to a second aspect the present invention relates to a non-transitory machine-readable medium comprising a plurality of machine-readable instructions which when executed by one or more processors of a computer are adapted to cause the computer to perform a method for determining the quality of running of a test subject comprising: receiving at least two orthogonal acceleration values a_{c} and a_{c′} of the test subject each at a plurality of times tᵢ, wherein a_{c} and a_{c′} are each one differently selected of the group of: acceleration a_{z} of the test subject in the down-up direction, acceleration a_{y} of the test subject in the right-left direction, and the acceleration aₓ of the test subject in the backward-forward direction; wherein the down-up direction, the left-right direction and the backward-forward direction form a Cartesian coordinate system for the test subject; determining the area Aᵢ defined by the origin (0,0) and the points (a_{c}(tᵢ),a_{c′}(tᵢ) and (a_{c}(tᵢ₋₁), a_{c′}(tᵢ₋₁)); and calculating the accumulated area A (t_{N})=Σᵢ₌₁^{N}Aᵢ by adding the areas Aᵢ until a point in time t_{N}.

According to a third aspect the present invention relates to a system for determining the quality of running of a test subject comprising: an accelerometer measuring at least two orthogonal acceleration values a_{c} and a_{c′} of the test subject each at a plurality of times tᵢ, wherein a_{c} and a_{c′} are each one differently selected of the group of: acceleration a_{z} of the test subject in the down-up direction, acceleration a_{y} of the test subject in the right-left direction, and the acceleration aₓ of the test subject in the backward-forward direction; wherein the down-up direction, the left-right direction and the backward-forward direction form a Cartesian coordinate system for the test subject; and a processor for determining the area Aᵢ defined by the origin (0,0) and the points (a_{c}(tᵢ),a_{c′}(tᵢ)) and (a_{c}(tᵢ₋₁), a_{c′}(tᵢ₋₁)), wherein the processor calculates the accumulated area A (t_{N})=Σᵢ₌₁^{N}Aᵢ by adding the areas Aᵢ until a point in time t_{N}.

Preferably, the processor is comprised of a smartphone and the steps of the invention are programed as an app running in the smartphone. This running app comprises a program of machine-readable instructions tangibly embodied on a non-transitory, computer-readable storage medium and executable by a digital processor when installed on a digital processing apparatus, such as a smartphone, wherein the running app comprising instructions for carrying out the steps according to the invention. The accelerometer which preferably comprises a three-dimensional acceleration sensor is, for instance, a separate component of the system, and is worn by the test subject in or on a belt around the waist of the test subject. The accelerometer can be positioned at the center front portion of the test subject's waist or at the center rear portion of the test subject's waist. For the components of the system being able to communicate, particularly for exchanging data such as acceleration measurements, the accelerometer and the processor are connected by a wireless technology standard for exchanging data over short distances, such as Bluetooth™.

According to a fourth aspect the present invention relates to a method for determining the quality of a cyclic locomotion of a test subject comprising the following steps: measuring at least two orthogonal acceleration values a_{c} and a_{c′} of the test subject each at a plurality of times tᵢ, wherein a_{c} and a_{c′} are each one differently selected of the group of: acceleration a_{z} of the test subject in the down-up direction, acceleration a_{y} of the test subject in the right-left direction, and the acceleration aₓ of the test subject in the backward-forward direction; wherein the down-up direction, the left-right direction and the backward-forward direction form a Cartesian coordinate system for the test subject; and determining the area of the closed trajectory of the acceleration values a_{c} and a_{c′} of the test subject in the a_{c} and a_{c′} coordinate system for at least one cycle. Therein, the locomotion is selected of the group of: walking, skipping, running and crawling. The locomotion can be a bipedal or quadrupedal locomotion. The cyclic or periodic nature of the locomotion ensures a closed curve which allows for area measurements to obtain a quality measure for the locomotion.

The above and still further features and advantages of the present invention will become apparent upon consideration of the following definitions, descriptions and descriptive figures of specific embodiments thereof wherein like reference numerals in the various figures are utilized to designate like components. While these descriptions go into specific details of the invention, it should be understood that variations may and do exist and would be apparent to those skilled in the art based on the descriptions herein.

### BRIEF DESCRIPTION OF THE DRAWINGS

In the drawings show:

FIG. 1 a schematic diagram showing the components and the set-up of the system according to an exemplary embodiment of the invention;

FIG. 2 a schematic diagram for explaining the determination of a quality measurement parameter or quality measure for a runner;

FIG. 3A in its upper portion acceleration values aₓ and a_{z} for a runner in a first phase of a running step cycle which is a flying phase with no contact to the floor, in its lower left portion the actual current position of the legs of a runner in this phase, and in its lower right portion the measured values of aₓ and a_{z} depicted in a diagram with aₓ in the x-direction and a_{z} in the negative z-direction, wherein the dot indicates the currently measured value for aₓ and a_{z};

FIG. 3B in its upper portion acceleration values aₓ and a_{z} for a runner in a second phase of a running step cycle which is the phase of maximum aₓ when the braking through contact to the floor sets in, in its lower left portion the actual current position of the legs of a runner in this phase, and in its lower right portion the measured values of aₓ and a_{z} depicted in a diagram with aₓ in the x-direction and a_{z} in the negative z-direction, wherein the dot indicates the currently measured value for aₓ and a_{z};

FIG. 3C in its upper portion acceleration values aₓ and a_{z} for a runner in a third phase of a running step cycle which is the phase of the beginning of the positive acceleration for a_{z} corresponding to push off, in its lower left portion the actual current position of the legs of a runner in this phase, and in its lower right portion the measured values of aₓ and a_{z} depicted in a diagram with aₓ in the x-direction and a_{z} in the negative z-direction, wherein the dot indicates the currently measured value for aₓ and a_{z};

FIG. 3D in its upper portion acceleration values aₓ and a_{z} for a runner in a fourth phase of a running step cycle which is the phase just before the first (flying) phase shown in FIG. 3A, in its lower left portion the actual current position of the legs of a runner in this phase, and in its lower right portion the measured values of aₓ and a_{z} depicted in a diagram with aₓ in the x-direction and a_{z} in the negative z-direction, wherein the dot indicates the currently measured value for aₓ and a_{z};

FIG. 4A and FIG. 4B the accumulated area sum parameter A for three different runners with various running styles, wherein the top curve depicts A for a heel-strike runner, the middle curve depicts A for a fore-foot runner with overstriding and the bottom curve depicts A for a fore-foot runner; the time scale being much wider in FIG. 4B than in FIG. 4A;

FIG. 5 a bar graph of the accumulated area sum parameter A per step for five different runners with various running styles; and

FIG. 6 a bar graph of the accumulated area sum parameter A per step for a single runner during various stages of a marathon with variable running speed in each stage.

### DETAILED DESCRIPTION

The present inventive concept is best described through certain embodiments thereof, which are described in detail herein with reference to the accompanying drawings, wherein like reference numerals refer to like features throughout. It is to be understood that the term invention, when used herein, is intended to connote the inventive concept underlying the embodiments described below and not merely the embodiments themselves. It is to be understood further that the general inventive concept is not limited to the illustrative embodiments described below and the following descriptions should be read in such light.

Additionally, the word exemplary is used herein to mean, “serving as an example, instance or illustration.” Any embodiment of construction, process, design, technique, etc., designated herein as exemplary is not necessarily to be construed as preferred or advantageous over other such embodiments. Particular quality or fitness of the examples indicated herein as exemplary is neither intended nor should be inferred.

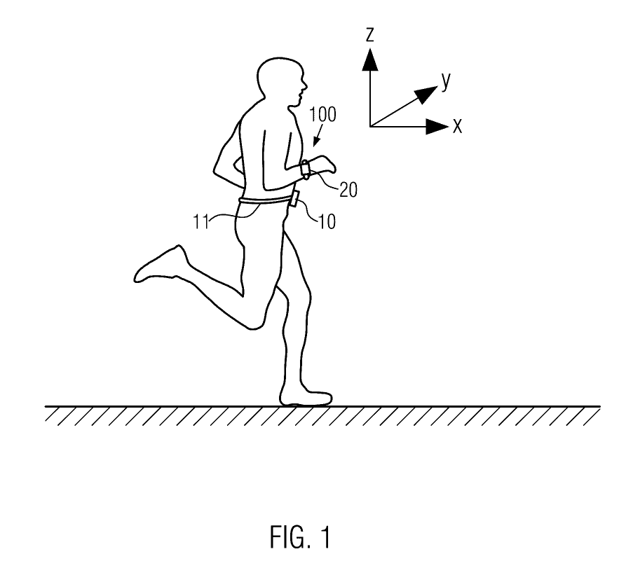

Referring now to FIG. 1 an exemplary embodiment of the system embodying the present invention will be described. The system 100 comprises a three-dimensional accelerometer comprising an acceleration sensor 10 such as the actibelt™ accelerometer described in the background section of the present specification. The acceleration sensor 10 is mounted behind a buckle (not shown) on a belt 11 which is worn around the waist of a test subject. This positioning allows for a reproducible positioning of the acceleration sensor 10 simply because people are used to properly buckling their belt with the buckle being oriented and aligned in a typical manner (“front-centered”). This arrangement also has the advantage that the three-dimensional acceleration sensor 10 is mounted in a symmetric location on the individual's body, i.e. located on the symmetry axis of the individual, and at a position close to the center of mass of the test subject so that the various sensed accelerations are largely independent. The sensor position is also fixed relative to the body which makes it actually more preferred than the actual center of mass position which would change by moving of the extremities such as arms and legs, thereby changing the moment of inertia. Generally, the acceleration sensor 10 could also be mounted at a different position of the test subject such as centered on its back, simply by wearing the actibelt™ the other way round. The acceleration sensor 10 measures the accelerations in the x, y and z directions wherein these directions are shown in FIG. 1. As a convention in this application (other conventions could be used) the x direction corresponds to the forward direction and the z direction corresponds to the upward direction. In order that the three directions from a Cartesian coordinate system the y direction points into the paper plane of FIG. 1, i.e. goes from right to left of the test subject moving to the right in the representation of FIG. 1. The accelerations are aₓ, a_{y} and a_{z} are measured simultaneously with a frequency of 100 Hertz and are transmitted via Bluetooth™ in real time to smartphone 20 which is exemplarily attached at the wrist of the test subject. In the smartphone 20 there is a mobile app processing the data received from the acceleration sensor 10 according to the inventive method. On a display screen of the smartphone 20 the results of the inventive processing can be displayed. Furthermore, other functionalities of smartphone 20 can be used in an advantageous manner in the context of the present invention. For instance, acoustic alarm signals could be generated and outputted via the loudspeaker of smartphone 20 to alert the individual when the quality of his or her running is considered to be bad or when there is a decrease in quality.

As is obvious for a skilled person there are many other ways for implementation of the system of the invention. For instance, the smartphone 20 might comprise the acceleration sensor 10 or the acceleration sensor 10 might be plugged directly on the Smartphone so as making a Bluetooth™ connection and attachment means for the second of two different components unnecessary. Alternative to smartphone 20 any other device which allows for processing the acceleration data may be used, particularly, a specially dedicated device to this purpose. In another embodiment without use of smartphone 20 the acceleration data could also be transmitted directly from the acceleration sensor 10 via the air interface, e.g. using 3G or 4G telecommunication techniques, which essentially means that a mobile telephone is integrated in the acceleration sensor. The acceleration data can be transmitted from the acceleration sensor 10 to a remote processing device such as another smartphone, e.g. of a coach of the individual runner. Alternatively, the acceleration data could also be stored within the acceleration sensor 10 itself and later be read out or transferred to a processing device such as a personal computer.

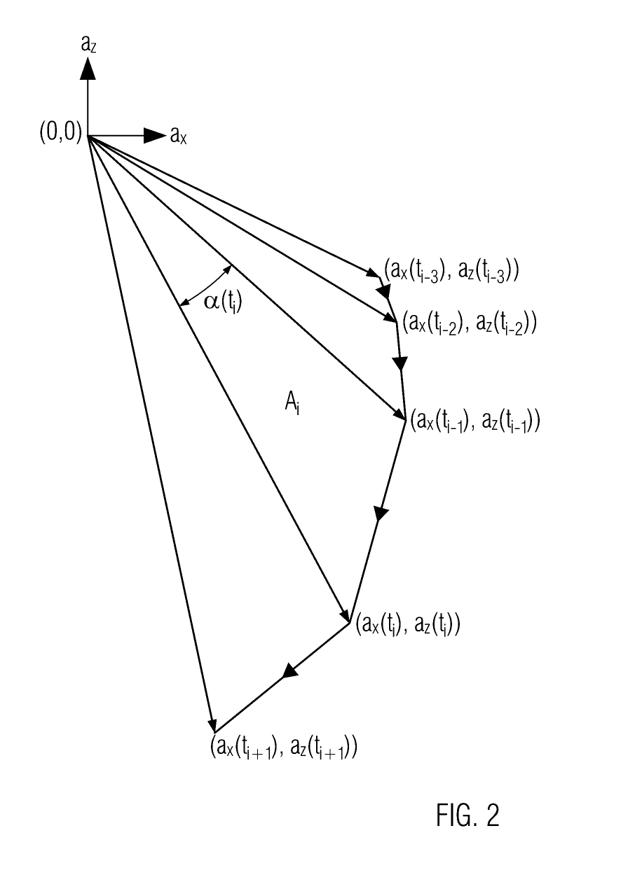

Turning now to FIG. 2 in connection with which the inventive method will be described. Although, the three-dimensional acceleration sensor 10 (FIG. 1) provides acceleration data in all three spatial directions it is preferred to use only two orthogonal accelerations in connection with the inventive method for analyzing the quality of running If all three acceleration values would be used then the results would be not so meaningful as will be explained below. Preferably, the acceleration values in the x and z directions, i.e. aₓ and a_{z}, will be used. They characterize the acceleration of the test subject in the down-up and the backward-forward directions, respectively. In FIG. 2, the acceleration values aₓ(tᵢ) and a_{z}(tᵢ) at time tᵢ are shown for various times (tᵢ₊₁, tᵢ, tᵢ₊₁, tᵢ₋₂, tᵢ₋₃) in a coordinate system with the abscissa being the acceleration aₓ in the x direction and the ordinate being the acceleration a_{z} in the z direction. Because of the gravitational acceleration of the earth it can clearly be seen that the acceleration values a_{z} in the z direction are all negative except at a point (0, 0), i.e. the origin of the coordinate system, which corresponds to the “flight phase” where the acceleration a_{z} in the z direction becomes 0 since the runner has left the ground with both feet. In this phase the runner experiences free fall. The subsequent values of (aₓ, a_{z}) for various times tᵢ provide points in the aₓ, a_{z} coordinate system which move along a balloon-like curve. Although the acceleration measurements are taken at regular time intervals with a frequency of 100 Hertz, the resultant points in the graphical illustration of FIG. 2 are not equidistant. Most measured points will lie in the area around of the origin since within a step the flight phase is the longest. Therefore, most part of this diagram describes the critical phases of landing of a foot or pushing off which are believed to be most crucial for evaluating the quality of running. In other words, the landing and pushing off phases are blown up due to the nature of the diagram and the nature of running. Since running itself is a quasi-period process, the term “quasi” is used in order to indicate that not every step is identical, the measured point (aₓ(tᵢ), a(tᵢ)) in this diagram will move around the balloon-like curve a plurality of times in the clockwise direction. For an ideal runner the center of mass should follow a trajectory of a straight line, i.e. it should be so to speak “elf-like” so that limb movement, rotation of the spinal cord/trunk during running should be zero even in response to different shoes/surfaces etc. Therefore, the quality of running should be the best, if the area enclosed by this curve is as small as possible. In other words, an ideal runner should be in a permanent flight phase. Therefore, it is preferred that the combination of two orthogonal acceleration values is for evaluating the quality of running Although generally possible, taking into account a third acceleration value would cancel out important information when looking at the size of the area which is generated in the acceleration space.

FIG. 2 shows how to calculate the area Aᵢ between the origin and two subsequent measurement points (aₓ(tᵢ), a_{z}(tᵢ)) and (aₓ(tᵢ₋₁), a_{z}(tᵢ₋₁)) which have been obtained at the times tᵢ and tᵢ₋₁, respectively. This area A, can be obtained through the following formula using trigonometry

$${A}_{i} = \frac{1}{2} \vert ( \begin{matrix}{a}_{x} ( {t}_{i - 1} ) \\ {a}_{z} ( {t}_{i - 1} )\end{matrix} ) \vert \cdot \vert ( \begin{matrix}{a}_{x} ( {t}_{i} ) \\ {a}_{z} ( {t}_{i} )\end{matrix} ) \vert \cdot sin α ( {t}_{i} )$$

wherein the angle α(tᵢ) between the lines defined by the origin and (aₓ(tᵢ), a_{z}(tᵢ)) and (aₓ(tᵢ₋₁), a_{z}(tᵢ₋₁)), respectively, can be obtained by the law of cosines to yield

$$sin α ( {t}_{i} ) = arccos \frac{{\vert ( \begin{matrix}{a}_{x} ( {t}_{i} ) - {a}_{x} ( {t}_{i - 1} ) \\ {a}_{z} ( {t}_{i} ) - {a}_{z} ( {t}_{i - 1} )\end{matrix} ) \vert}^{2} - {\vert ( \begin{matrix}{a}_{x} ( {t}_{i - 1} ) \\ {a}_{z} ( {t}_{i - 1} )\end{matrix} ) \vert}^{2} - {\vert ( \begin{matrix}{a}_{x} ( {t}_{i} ) \\ {a}_{z} ( {t}_{i} )\end{matrix} ) \vert}^{2}}{2 \vert ( \begin{matrix}{a}_{x} ( {t}_{i - 1} ) \\ {a}_{z} ( {t}_{i - 1} )\end{matrix} ) \vert \cdot \vert ( \begin{matrix}{a}_{x} ( {t}_{i} ) \\ {a}_{z} ( {t}_{i} )\end{matrix} ) \vert}$$

According to the present invention these partial areas Aᵢ can be summed up to yield a quality parameter for running

$$A ( {t}_{N} ) = {\sum }_{i = 1}^{N} {A}_{i} = \frac{1}{2} {\sum }_{i = 1}^{N} \vert ( \begin{matrix}{a}_{x} ( {t}_{i - 1} ) \\ {a}_{z} ( {t}_{i - 1} )\end{matrix} ) \vert \cdot \vert ( \begin{matrix}{a}_{x} ( {t}_{i} ) \\ {a}_{z} ( {t}_{i} )\end{matrix} ) \vert \cdot sin α ( {t}_{i} )$$

The unit of this accumulated sum area A(t_{N}) is

$$[ \frac{{m}^{2}}{{s}^{4}} ]$$

since it is an area in a space defined by two accelerations. The accumulated area can be taken as a sliding mean value, wherein this sliding mean value can also be a weighted sliding mean value, wherein, for instance, various stages of the curve shown in FIG. 2 can be weighted differently. The accumulated sum area sliding mean value A(t_{N}) can be taken over a constant time interval Δt, a constant number of steps Δt_{N}, in particular, one step, or over a certain distance Δt_{N′}. In case it is taken over a constant number of steps, of course, the steps have to be detected wherein it is clear from FIG. 2 that a step can be defined as the trajectory of the measured acceleration values going through the origin. Of course, alternatively, a pedometer or step counter could be used for step detection. When the sliding mean of the accumulated sum is taken over certain distance then the speed has to be measured externally, for instance, with additional GPS data, e.g. obtained through the smartphone 20. Due to the finite resolution of the measurement of the acceleration values the accumulated sum area A(t_{N}) is an approximation of the curve enclosed by the trajectory formed by the acceleration values in the acceleration coordinate space/system, with the approximation becoming better when the resolution is increased.

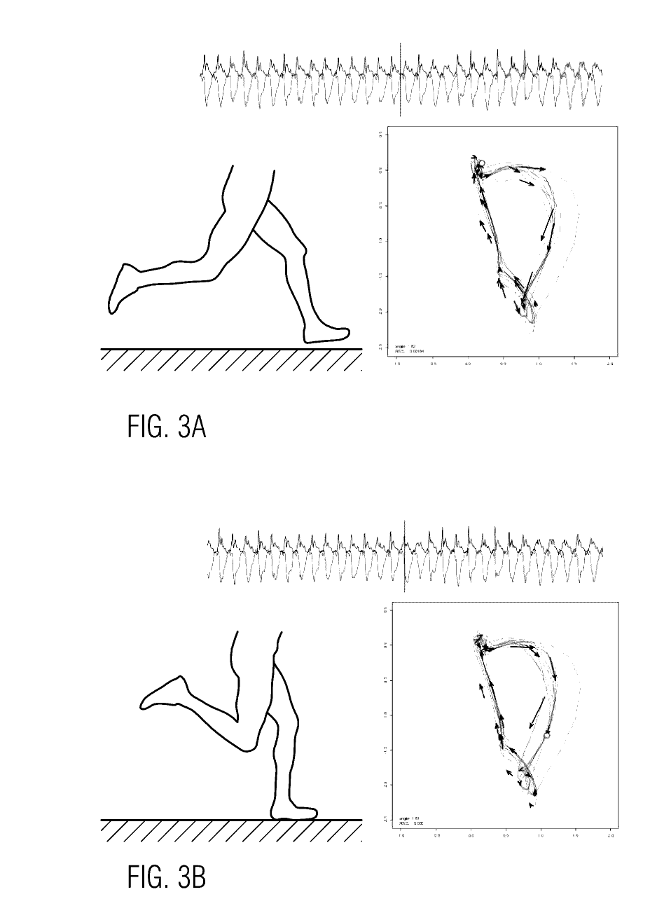

Referring now to FIGS. 3A to 3D four different phases of a running cycle (recorded for a runner on a treadmill) are schematically illustrated. The upper portion of each of these Figures shows the acceleration aₓ into the x direction, whereas the lower curve of the upper portion shows the acceleration a_{z} in the z direction. One can clearly see the double peaks of the lower a_{z} acceleration curve which show that there is a double peak caused by the heel of the foot striking first the ground followed by the remainder of the foot. Further, one can see that the range of occurring acceleration values is larger for a_{z} than for aₓ so that in the diagram of the lower right portion FIGS. 3A to 3D showing aₓ on the abscissa and a_{z} on the ordinate (into which the acceleration values of the upper portion of each Figure have been plotted) the vertical extension of the resulting curve is larger than in the horizontal direction. In the lower left portion of the respective FIGS. 3A to 3D the actual position of the legs of the runner are shown for the current time which is also indicated by a dot in the trajectory shown in the lower right portion of the respective FIG. 3A to 3D.

One can clearly see that during running in the coordinate space defined by the aₓ and a_{z} accelerations a somewhat balloon-shaped trajectory is passed in the clockwise direction. In each flight phase corresponding to the origin (0, 0) the trajectory returns to its upper left extension. FIG. 3A shows a first phase of a running step cycle which is the flying phase with the runner's feet making no contact to the ground and which is the “calibration point” for the measurement. FIG. 3B shows a second phase of a running step cycle which is the phase of maximum forward acceleration aₓ when the braking through contact to the floor sets in and slows down the forward acceleration. FIG. 3C shows a third phase of the running step cycle in which the positive acceleration against the gravitational acceleration for a_{z} just started corresponding to a push off of the runner's foot on the ground. FIG. 3D shows a fourth phase of a running step cycle which is the phase just before the first (flying phase) shown in FIG. 3A.

For each measured position (only four such measurements are shown in FIGS. 3A to 3D) the area of the curve is determined, in particular, calculated as has been described above in connection with the schematic diagram shown in FIG. 2. Then, accumulated sums are calculated as has been described above.

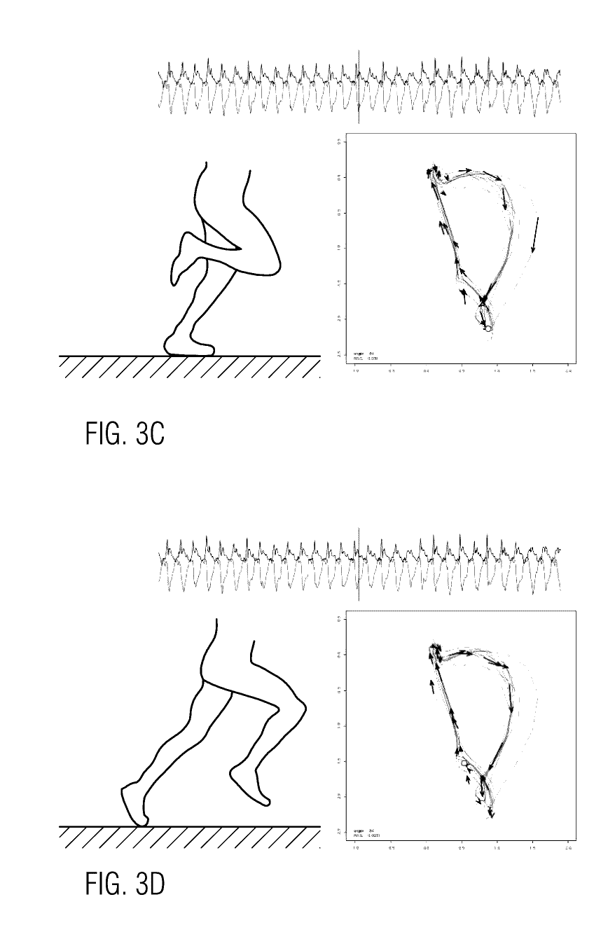

In FIG. 4A and 4B the accumulated area sum A(t_{N}) is shown for three different running styles. The diagrams of 4A and 4B show the same measurements, with FIG. 4A essentially showing the first second of the running process, whereas FIG. 4B shows the first 60 seconds, i.e. at a much smaller scale. The upper curve shows a heel-strike running style (heel-strike: the runner sets first the heel onto the ground during the landing phase). The middle curve shows a fore-foot running style with overstriding (overstride: the foot comes into contact with the ground well ahead of the hips or ahead of the center of gravity) and the bottom curve shows a fore-foot running style (forefoot-strike: the runner sets first the fore-foot onto the ground during the landing phase). The “steps” shown in the curves of FIG. 4A correspond to respective flight phase, i.e. indicate real steps of the runner. It has been recognized by the present inventor that a low value of the accumulated area sum A(t_{N}) corresponds to a better running style or quality. This is in line with the experimental results shown in 4A and 4B inasmuch as the best running style is generally considered to be the fore-foot running style, followed by the heel-strike running style. The type of running style shown in the middle curve (fore-foot running style with overstriding) can be recognized as being of a running quality in between the forefoot striker and the heel-striker.

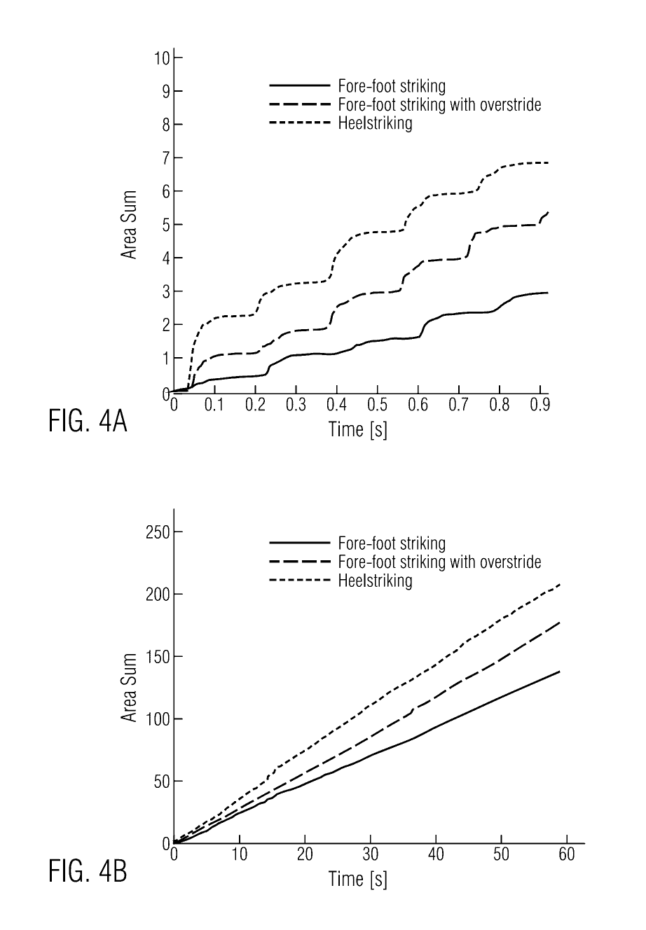

FIG. 5 shows experimentally obtained values for the accumulated area sum A per step (with some normalization). The experimental data shown in FIG. 5 were taken on a treadmill with a uniform speed and which, of course, comprises a damping. One can clearly see the different values obtained on the top of the bar graph diagram showing that the forefoot-strike runner has the lowest A value of 0.83. This is followed by an A of 1.09 by the heel-strike runner wherein heel-strike running is generally considered as being of worse quality (e.g. more likely to cause injuries) than fore-foot running The extreme heel-strike runner has an A value of 1.19 which is, of course, considered a worse running style than the heel-strike running The heel-strike runner with overstride, i.e. the runner sets the foot onto the ground before the center of mass, which is also considered a very bad quality of running yields an A value of 1.33. Really bad is a running style with fore-foot strike with overstride which again yields a bad A value of 1.34.

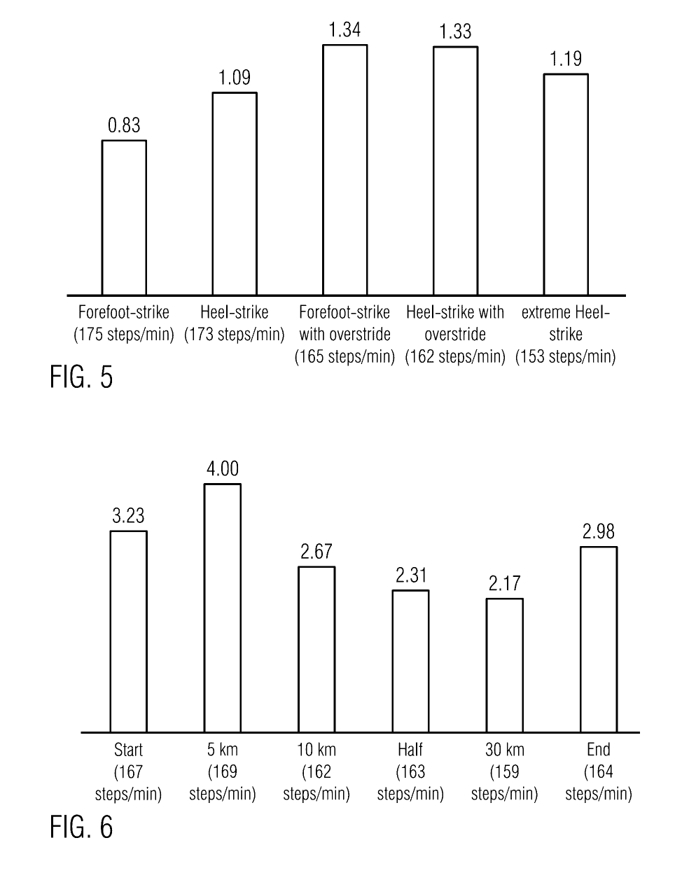

The experimental data shown in FIG. 6 were taken outdoors during a marathon. The various A values indicated in the bar diagram of FIG. 6 show A per step at the start of the marathon, after 5 kilometers, after 10 kilometers, at half-time, after 30 kilometers and at the end. One can clearly see that different A values are obtained when the runner runs in realistic conditions, i.e. without the damping of a treadmill, with different speeds, the effects of fatigue etc. The overall result of this bar graph diagram is that the running style was believed to be optimum between 10 to 30 kilometers during the marathon.

Having described preferred embodiments of new and improved method and system for determining the quality of running, it is believed that other modifications, variations and changes will be suggested to those skilled in the art in view of the teachings set forth herein. It is therefore to be understood that all such variations, modifications and changes are believed to fall within the spirit and scope of the present invention as defined by the appended claims. Although specific terms are employed herein, they are used in a generic and descriptive sense only and not for purposes of limitation. Various publications are cited herein, the disclosures of which are incorporated by reference in their entireties.

What is claimed is:

1. A method for determining the quality of running of a test subject comprising the following steps:
measuring at least two orthogonal acceleration values a_{c} and a_{c′} of the test subject each at a plurality of times tᵢ, wherein a_{c} and a_{c′} are each one differently selected of the group of: acceleration a_{z} of the test subject in the down-up direction, acceleration a_{y} of the test subject in the right-left direction, and the acceleration aₓ of the test subject in the backward-forward direction; wherein the down-up direction, the left-right direction and the backward-forward direction form a Cartesian coordinate system for the test subject;
determining the area Aᵢ defined by the origin (0,0) and the points (a_{c}(tᵢ),a_{c′}(tᵢ)) and (a_{c}(tᵢ₋₁), a_{c′}(tᵢ₋₁)); and
calculating the accumulated area A(t_{N})=Σᵢ₌₁^{N} Aᵢ by adding the areas Aᵢ until a point in time t_{N}.

2. The method of claim 1, wherein the method further comprises a step of evaluating A(t_{N}) for obtaining the quality of running of the test subject, wherein the step of evaluating A(t_{N}) further comprises:
obtaining a sliding mean value for A(t_{N}) for a time interval t_{N}-Δt_{N} to t_{N}; and
comparing A for different times t_{N} and t_{N′}, wherein a lower value of A indicates a better quality of running, wherein equal values of A indicate the same quality of running, wherein a higher value of A indicates a worse quality of running, and wherein the different times t_{N} and t_{N′} form part of the same measurement series or of different measurement series, and/or
comparing A with a predetermined threshold value, wherein a value of A lower than or equal to the predetermined threshold value indicates a good quality of running, and wherein value of A higher than the predetermined threshold value indicates a bad quality of running

3. The method of claim 1, wherein the sliding mean value for A(t_{N}) is a weighted sliding mean value.

4. The method of claim 2, wherein the sliding mean value for A(t_{N}) is determined per time unit, and wherein Δt_{N} is a constant time interval Δt equal to the time unit.

5. The method of claim 2, further comprising
determining steps of the test subject;
wherein the sliding mean value for A(t_{N}) is determined per n steps, wherein n is a positive integer, and wherein Δt_{N} is a time interval corresponding to n steps of the test subject.

6. The method of claim 2, further comprising
determining the speed of the test subject;
wherein the sliding mean value for A(t_{N}) is determined per distance unit, and wherein Δt_{N} is a time interval corresponding to the distance unit passed by the test subject.

7. The method of claim 1, wherein A(t_{N}) is given by the following formula:
$$A ( {t}_{N} ) = {\sum }_{i = 1}^{N} {A}_{i} = \frac{1}{2} {\sum }_{i = 1}^{N} \vert ( \begin{matrix}{a}_{c} ( {t}_{i - 1} ) \\ {a}_{c ′} ( {t}_{i - 1} )\end{matrix} ) \vert \cdot \vert ( \begin{matrix}{a}_{c} ( {t}_{i} ) \\ {a}_{{c}^{′}} ( {t}_{i} )\end{matrix} ) \vert \cdot sin α ( {t}_{i} )$$
wherein α(tᵢ) is the angle between the vectors (a_{c}(tᵢ₋₁),a_{c′}(tᵢ₋₁)) and (a_{c}(tᵢ),a_{c′}(tᵢ)).

8. The method of claim 1, wherein the acceleration values a_{c} and a_{c′} of the test subject are each measured with a frequency of 100 Hz.

9. The method of claim 1, wherein the selected orthogonal acceleration values a_{c} and a_{c′} are aₓ and a_{z}.

10. The method of claim 1, further comprising displaying the measured acceleration values a_{c}(t) and a_{c′}(t) for subsequent times tᵢ in a two-dimensional Cartesian coordinate system with the abscissa being the a_{c} axis and the ordinate being the a_{c′} axis.

11. A non-transitory machine-readable medium comprising a plurality of machine-readable instructions which when executed by one or more processors of a computer are adapted to cause the computer to perform a method for determining the quality of running of a test subject comprising:
receiving at least two orthogonal acceleration values a_{c} and a_{c′} of the test subject each at a plurality of times tᵢ, wherein a_{c} and a_{c′} are each one differently selected of the group of: acceleration a_{z} of the test subject in the down-up direction, acceleration a_{y} of the test subject in the right-left direction, and the acceleration aₓ of the test subject in the backward-forward direction; wherein the down-up direction, the left-right direction and the backward-forward direction form a Cartesian coordinate system for the test subject;
determining the area Aᵢ defined by the origin (0,0) and the points (a_{c}(tᵢ),a_{c′}(tᵢ)) and (a_{c}(tᵢ₋₁), a_{c′}(tᵢ₋₁)); and
calculating the accumulated area A (t_{N})=Σᵢ₌₁^{N} Aᵢ by adding the areas Aᵢ until a point in time t_{N}.

12. A system for determining the quality of running of a test subject comprising:
an accelerometer measuring at least two orthogonal acceleration values a_{c} and a_{c′} of the test subject each at a plurality of times tᵢ, wherein a_{c} and a_{c′} are each one differently selected of the group of: acceleration a_{z} of the test subject in the down-up direction, acceleration a_{y} of the test subject in the right-left direction, and the acceleration aₓ of the test subject in the backward-forward direction; wherein the down-up direction, the left-right direction and the backward-forward direction form a Cartesian coordinate system for the test subject; and
a processor for determining the area Aᵢ defined by the origin (0,0) and the points (a_{c}(tᵢ),a_{c′}(tᵢ)) and (a_{c}(tᵢ₋₁), a_{c′}(tᵢ₋₁)), wherein the processor calculates the accumulated area A(t_{N})=Σᵢ₌₁^{N} Aᵢ by adding the areas Aᵢ until a point in time t_{N}.

13. The system of claim 12, wherein the processor is comprised of a smartphone.

14. The system of claim 12, wherein the accelerometer is worn by the test subject in or on a belt around the waist of the test subject.

15. The system of claim 12, wherein the accelerometer is positioned at the center front portion of the test subject's waist.

16. The system of claim 12, wherein the accelerometer is positioned at the center rear portion of the test subject's waist.

17. The system of claim 12, wherein the accelerometer transmits its measured acceleration values to the processor using wireless technology standard for exchanging data over short distances, such as Bluetooth™.

18. A method for determining the quality of a cyclic locomotion of a test subject comprising the following steps:
measuring at least two orthogonal acceleration values a_{c} and a_{c′} of the test subject each at a plurality of times tᵢ, wherein a_{c} and a_{c′} are each one differently selected of the group of: acceleration a_{z} of the test subject in the down-up direction, acceleration a_{y} of the test subject in the right-left direction, and the acceleration aₓ of the test subject in the backward-forward direction; wherein the down-up direction, the left-right direction and the backward-forward direction form a Cartesian coordinate system for the test subject; and
determining the area of the closed trajectory of the acceleration values a_{c} and a_{c′} of the test subject in the a_{c} and a_{c′} coordinate system for at least one cycle.

19. The method according to claim 18, wherein the locomotion is selected of the group of: walking, skipping, running and crawling.

20. The method according to claim 18, wherein the locomotion is selected of the group of: bipedal and quadrupedal locomotion.
